(19) United States
(12) Patent Application Publication
(10) Pub. No.: US 2026/0199716 A1
(43) Pub. Date: Jul. 16, 2026

(54) CLAMP FOR ANCHORING A SAFETY HARNESS TO A RAIL SYSTEM AND A METHOD OF USING SAME

(71) Applicant: Autostore Technology AS, Nedre Vats (NO)

(72) Inventors: Trond Austrheim, Etne (NO); Ivar Fjeldheim, Haugesund (NO); Martin Fitje, Etne (NO); Geir Vikingstad, Haugesund (NO)

(73) Assignee: Autostore Technology AS, Nedre Vats (NO)

(21) Appl. No.: 19/136,526

(22) PCT Filed: Nov. 27, 2023
(86) PCT No.: PCT/EP2023/083094

§ 371 Date: Jun. 6, 2025

(30) Foreign Application Priority Data
Dec. 9, 2022 (NO) 20221324

(51) Int. Cl. A62B 35/00; B65G 1/04

(52) U.S. Cl. CPC A62B 35/0068; A62B 35/0062; B65G 1/0464

(57) ABSTRACT

It is disclosed a clamp for anchoring a safety harness to a rail system, wherein the rail system comprises: —a first set of parallel rails arranged in a horizontal plane and extending in a first direction, and—a second set of parallel rails arranged in the horizontal plane and extending in a second direction which is orthogonal to the first direction, wherein the first and second sets of rails form a grid pattern in the horizontal plane, the grid pattern comprising a plurality of openings, each opening being defined by a pair of neighboring rails of the first set of rails, a pair of neighboring rails of the second set of rails, and four junctions where each rail of the first set of rails meets one of the rails of the second set of rails, wherein the clamp comprises: —an attachment point for a safety harness, —a first jaw, and—a second jaw, wherein the clamp is operable between clamped and released configurations to pivot the jaws relative to each other and thereby adjust a jaw gap between distal ends of the jaws, wherein the first jaw and the second jaw are configured to engage opposite sides of a rail of the first set of rails or the second set of rails when the clamp is in the clamped configuration, and/or wherein the first jaw and the second jaw are configured to engage opposite corners of the junction when the clamp is in the clamped configuration.

### FIELD OF THE INVENTION

The present invention relates to a safety device for an automated storage and retrieval system for storage and retrieval of containers, in particular to a clamp providing a connection point for a safety harness.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b, 401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c, 401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO 2014/090684A1 or WO 2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

During the lifecycle of a storage system, maintenance on top of the rail system may be required. Alternatively, maintenance may be required in an area of the system accessible via the top of the rail system. If such maintenance is to be performed by an operator, a safety harness should be worn by the operator and secured to a connection point in order to prevent injuries or at least limit injuries caused by falling.

Different means have been suggested for providing a temporary connection point for a safety harness. Scissorsafe™ has a product referred to as a “Sliding Beam Clamp-Fall Protection Anchor Device” which is available online. This device has two paws that can be adjusted in a sliding manner allowing a Dee ring to be attached to a beam, e.g. to an I-beam or a H-beam. The device is designed to slide along the beam as the user traverses its length and can be used with beams of different sizes.

The rail system of the automated storage and retrieval system does not typically have a web and flange geometry such as the H and I-beams. The prior art sliding beam clamp would thus not fit the profile of the rail system.

Furthermore, when connecting the prior art sliding beam clamp to a beam, the sliding beam clamp must be operated from substantially the same vertical elevation as the beam. This may be cumbersome and dangerous for the operator, e.g. if the operator must lean over a fence or on the outside of a service vehicle transporting them on the rail system.

Additionally, the prior art sliding beam clamp may damage the tracks provided on top of the rail system, particularly in the event of a falling operator. Forces from the sliding beam clamp acting on top of the rail system may deform or compress the tracks.

An aim of the present invention is to provide a clamp for securing an operator to the rail system and which alleviates or mitigates at least some of the disadvantages related to the known beam clamps.

### SUMMARY OF THE INVENTION

The present invention is set forth and characterized in the independent claims, while the dependent claims describe other characteristics of the invention.

The present disclosure relates to a clamp for anchoring a safety harness to a rail system, wherein the rail system comprises: a first set of parallel rails arranged in a horizontal plane and extending in a first direction X, and a second set of parallel rails arranged in the horizontal plane and extending in a second direction Y which is orthogonal to the first direction, wherein the first and second sets of rails form a grid pattern in the horizontal plane, the grid pattern comprising a plurality of openings, each opening being defined by a pair of neighbouring rails of the first set of rails, a pair of neighbouring rails of the second set of rails, and four junctions where each rail of the first set of rails meets one of the rails of the second set of rails, wherein the clamp comprises: an attachment point for a safety harness, a first jaw, and a second jaw, wherein the clamp is operable between clamped and released configurations to pivot the jaws relative to each other and thereby adjust a jaw gap between distal ends of the jaws, wherein the first jaw and the second jaw are configured to engage opposite sides of a rail of the first set of rails or the second set of rails when the clamp is in the clamped configuration and/or wherein the first jaw and the second jaw are configured to engage opposite corners of the junction when the clamp is in the clamped configuration.

The first jaw and the second jaw may be configured to hold the clamp in place by means of friction against the rail(s), when the clamp is arranged on the rail system in the clamped configuration. This may be achieved e.g. by means of the surface roughness of the jaws or the material used for the jaws/the entire clamp.

By connecting the clamp to opposite corners of the junction, the clamp will be fixed in all directions. The clamp may then hold the weight of a falling operator without applying a force on the top surface of the rail system. The risk of damaging the tracks provided on top of the rail system can thus be avoided.

Furthermore, the clamp will be fixed in all directions without relying on friction between the clamp and the rails.

By connecting the clamp to a junction of the rail, there is also less opportunity for torsion-induced deflection of the rails because of the cross-shape and uniform support around the junction (acting like spokes of a wheel to ground the forces from a fall).

Each one of the rails in the rail system has a rail width R_{W}. All rail of the first set of parallel rails typically have the same rail width. All rail of the second set of parallel rails typically have the same rail width. In preferred configurations of the rail system, all rails of both the first and second sets of parallel rails typically have the same rail width.

In the clamped configuration of the clamp, the jaw gap J_{G} will typically correspond to about the rail width multiplied by root two, i.e. J_{G}=R_{w}·\sqrt{2}.

The jaws may be configured to grip on vertical sides of the rails. Alternatively, or additionally, the jaws may be configured to grip under the rails.

By configuring the clamp to only clamp onto the rails in a correct way. A more fool-proof clamp is achieved. The clamp can thus provide improved safety as a clamp not properly fixed may cause a safety risk for the operator.

With the first jaw and the second jaw engaging opposite corners of the junction when the clamp is in the clamped configuration, the corners where the rails abut each other will provide support to the clamp to prevent it from being pulled over /twisted in the event of an accident.

The attachment point for the safety harness is preferably as close to the rail and anchoring point as possible. This will at least to some extent prevent the clamp from being levered open or otherwise forced off the rails in the event of an accident.

The clamp may comprise a first tooth arranged on the first jaw, and a second tooth arranged on the second jaw.

Each rail may comprise two vertical sides and may be formed with a horizontal groove provided in each vertical side of the rail, wherein the grooves on the first set of parallel rails may be positioned to align with the grooves on the second set of parallel rails at the junctions, wherein the first tooth and the second tooth are configured to engage grooves on opposite sides of a rail of the first set of rails or the second set of rails when the clamp is in the clamped configuration, and/or wherein the first tooth and the second tooth may be configured to engage the grooves across opposite corners of the junction between a rail extending in the first direction and a rail extending in the second direction when the clamp is in the clamped configuration.

The horizontal grooves provide an additional lock for the clamp on the vertical sides of the rails to prevent it from ripping out.

The clamp may be arranged to be operated as a scissor mechanism to clamp the jaws around one rail or the junction of the rails.

The clamp may have a scissor mechanism which allows an operator to connect it to the rail system at a distance from the rail system (e.g. while sitting in a service vehicle) given the clamp has a sufficient length. The length L of the clamp may e.g. be at least 50 cm. The clamp can thus allow easy reach for an operator not having to bend down too far and thus improve operational safety.

The clamp may be self-locking, e.g. a locking plier type.

The clamp may comprise a first arm, and a second arm connected to the first arm at a pivot, wherein the first arm and the second arm each have a first part and a second part, the first parts and the second parts are on opposite sides of the pivot, wherein the first parts may form levers and the second parts may form the jaws, such that the levers can be used to operate the jaws relative each other.

The levers may be handles for the operator to grab the clamp and operate it between the clamped and released configurations.

The first lever, the second lever, the first jaw, and the second jaw may be parallel when the clamp is in the clamped configuration.

The clamp may comprise a releasable locking mechanism configured to lock the jaws in a clamped configuration.

The proper engagement of the horizontal grooves by the teeth may be ensured by being needed in order for the clamp to close and the locking mechanism to snap shut, the grooves effectively allowing the extra movement of the jaws into the clamped configuration.

The locking mechanism may comprise a releasable lock pin. The lock pin may be biased towards a locking position. The lock pin may then lock with a noticeable click for the operator. The lock pin may be arranged on the first lever. A locking hole may be provided on the second lever at a position allowing the lock pin to enter when the clamp is in the clamped configuration.

When fitted correctly such that the handles/levers of the clamp come together and the locking mechanism snaps shut, the junction offers stability for the fixing of the clamp to prevent the clamp from sliding along the rails if the operator were to fall off the grid.

The clamp may comprise an attachment part arranged in the second part of the first arm, wherein the attachment point is a through-hole arranged in the attachment part.

The attachment part is preferably arranged below the levers/handles and the pivot/pivot point of the clamp, such that the safety harness is anchored as close to the junction as possible.

The safety harness may be connected to the attachment part at any time. However, the operator may not have to bend down to connect the safety harness to the clamp if they are connected to each other before the clamp is connected to the rail.

The teeth may be configured to be engaged with the grooves of the rail system when the clamp is operated such that the first jaw and the second jaw are parallel.

The first jaw and the second jaw may then align with the vertical sides of the rails.

The first tooth and the second tooth may point towards each other when the jaws are parallel. The first tooth and the second tooth are then preferably extending in parallel directions. The first tooth and the second tooth are then preferably in-line.

The jaw gap is greater than zero when the first jaw is parallel with the second jaw.

The jaw gap is greater than the horizontal diagonal of a junction when the first jaw is parallel with the second jaw. However, the jaw gap should be small enough to provide a tight fit between the clamp and the rails at a junction.

The junction is defined by the area wherein two rails overlap. the junction may be referred to as a track crossing.

The jaw gap may be 30-100 mm when the clamp is in the clamped configuration. More preferred the jaw gap may be 35-75 mm when the clamp is in the clamped configuration.

The jaw gap may be configured to clamp a double-double track rail configuration. The jaw gap may then be 70-75 mm when the clamp is in the clamped configuration, e.g. 71 mm.

The jaw gap may be configured to clamp a single-single track rail configuration. The jaw gap may then be 35-40 mm when the clamp is in the clamped configuration, e.g. 36 mm.

The jaw gap may be configured to clamp a double-double track rail configuration. The jaw gap may then be 55-60 mm when the clamp is in the clamped configuration, e.g. 56 mm.

The second part of the first arm may form a surface for the clamp to be supported on top of the rail system.

The surface may be part of the attachment part.

The surface may be arranged at a distance from the first tooth defining a jaw depth J_{D}, wherein the jaw depth corresponds to a distance between the top of the rail and the groove.

The shape of the jaws and the teeth is typically dictated by the sizing of the rails.

The jaw depth may be at least 50 mm, preferably 50-150 mm, more preferred 75-115 mm.

The teeth may be pointed to take account of the internal corner profile where two grooves meet at the junction.

The first tooth and the second tooth may have different heights to allow the pivoting movement of one jaw into the clamping position.

The first jaw may have an inner side and the second jaw has an inner side, wherein the inner side of the first jaw and the inner side of the second jaw face each other, wherein the inner side of the first jaw may be chamfered towards the second jaw and the inner side of the second jaw may be chamfered towards the first jaw.

By means of the chamfering on the inner side of the first jaw and the second jaw, the jaws may be brought closer to a junction of two rails.

The chamfering of the first jaw may form a 90° angle and the chamfering of the second jaw may form a 90° angle.

The jaws then have a pointed/flat-nosed triangular shape corresponding to the profile in the corner of the junction.

The chamfering of the first jaw and the chamfering of the second jaw may form pairwise parallel surfaces.

The side surfaces of the teeth are thus configured to align with the parallel side surfaces of the rails.

The inner side of the first jaw may be configured to engage one vertical side of one of the rails extending in the first direction and simultaneously engage one vertical side of one of the rails extending in the second direction, and
the inner side of the second jaw may be configured to engage another vertical side of the rail extending in the first direction and simultaneously engage another vertical side of the rail extending in the second direction such that the clamp straddle the junction,
when the clamp is in the clamped configuration and the first tooth and the second tooth engage respective grooves on opposite corners of the junction.

The chamfered parts of the first jaw and the second jaw will typically be configured to engage the vertical sides of the rails.

The first tooth may extend towards the second jaw and the second tooth may extend towards the first jaw, wherein the first tooth may be chamfered towards the second jaw and the second tooth may be chamfered towards the first jaw.

The first teeth and the second teeth then have a pointed/flat-nosed triangular shape corresponding to the groove profile in the corner of the junction.

By means of the chamfering on the first tooth and the second tooth, the teeth may be brought closer to the grooves at a junction of two rails.

By means of the chamfering on the first tooth and the second tooth, the teeth may get greater contact surfaces with the grooves.

By means of the chamfering on the first teeth and the second teeth, the jaws may nest into the vertical surfaces of the corner of the junction.

The chamfering of the first tooth may form a 90° angle and the chamfering of the second tooth may form a 90° angle.

The chamfering of the first tooth and the chamfering of the second tooth may form pairwise parallel surfaces.

The chamfering of the first tooth and the chamfering of the first jaw may form pairwise parallel surfaces, and the chamfering of the second tooth and the chamfering of the second jaw may form pairwise parallel surfaces.

The releasable locking mechanism may be arranged on the first lever and configured to releasably lock the first lever to the second lever, such that relative movement between the first lever and the second lever is prevented.

The releasable locking mechanism may preferably be placed in an upper part of the clamp. It that way the releasable locking mechanism can be easily accessed by an operator when the clamp is connected to the rail system.

The releasable locking mechanism may be biased towards a locked position by means of a spring.

The first part of the first arm may be provided with an opening through which the second arm is sandwiched.

The pivot may be arranged at a point where the second arm is sandwiched by the first arm.

The present disclosure relates to a safety system for use on a rail system, wherein the rail system comprises: a first set of parallel rails arranged in a horizontal plane and extending in a first direction X, and a second set of parallel rails arranged in the horizontal plane and extending in a second direction Y which is orthogonal to the first direction, wherein the first and second sets of rails form a grid pattern in the horizontal plane, the grid pattern comprising a plurality of openings, each opening being defined by a pair of neighbouring rails of the first set of rails, a pair of neighbouring rails of the second set of rails, and four junctions where each rail of the first set of rails meets one of the rails of the second set of rails, wherein the safety system comprises: a clamp as disclosed herein, a safety harness, and, a tether.

The safety harness may comprise a shoulder strap, a chest strap, leg straps, a waist strap, a dorsal ring, or any combinations thereof.

The tether may comprise a carabiner, a shock absorber, a lanyard, a snap hook, or any combinations thereof.

An operator will typically wear the safety harness which can be anchored to the rails by means of the clamp. The safety harness may be connected to the clamp by the tether.

The carabiner of the tether can be connected to the dorsal ring of the safety harness. The snap hook(s) can be connected to the attachment point of the clamp, either before or after the clamp is connected to the rail.

The safety system may comprise one or more service plate(s) for covering up an opening in the rail system. The service plates can be used to form a platform for an operator at a service area.

The present disclosure relates to an automated storage and retrieval system, wherein the automated storage and retrieval system comprises: a clamp as disclosed herein, and a rail system, wherein the rail system comprises: a first set of parallel rails arranged in a horizontal plane and extending in a first direction X, and a second set of parallel rails arranged in the horizontal plane and extending in a second direction Y which is orthogonal to the first direction, wherein the first and second sets of rails form a grid pattern in the horizontal plane, the grid pattern comprising a plurality of openings, each opening being defined by a pair of neighbouring rails of the first set of rails, a pair of neighbouring rails of the second set of rails, and four junctions where each rail of the first set of rails meets one of the rails of the second set of rails.

Each rail may comprise two horizontal grooves arranged on respective vertical sides of the rail, wherein the grooves on the first set of parallel rails may be arranged to intersect the grooves on the second set of parallel rails at junctions between the first set of parallel rails and the second set of parallel rails.

The automated storage and retrieval system may comprise the safety system.

The first tooth and the second tooth may have thicknesses matching the height of the grooves.

The automated storage and retrieval system may comprise a plurality of upright members supporting the rail system, wherein the upright members are arranged directly below the junctions.

When the clamp engages opposite corners of the junction, the junction will directly transfer loads via the upright member below to the floor of the warehouse.

The framework structure may comprise upright members and a storage volume comprising storage columns arranged in rows between the upright members. In these storage columns storage containers are stacked one on top of one another to form stacks. The members may typically be made of metal, e.g. extruded aluminum profiles.

The rail system may be arranged across the top of the framework structure, on which rail system a plurality of container handling vehicles may be operated to raise storage containers from, and lower storage containers into, the storage columns, and also to transport the storage containers above the storage columns.

The first set of parallel rails is arranged to guide movement of the container handling vehicles in the first direction X across the top of the frame structure, and the second set of parallel rails is arranged perpendicular to the first set of rails to guide movement of the container handling vehicles in the second direction Y which is perpendicular to the first direction X. Containers stored in the columns are accessed by the container handling vehicles through openings in the rail system. The container handling vehicles can move laterally above the storage columns, i.e. in a plane which is parallel to the horizontal X-Y plane.

The upright members of the framework structure may be used to guide the storage containers during raising of the containers out from and lowering of the containers into the columns. The stacks of containers are typically self-supporting.

The automated storage and retrieval system may comprise: a service vehicle for transporting an operator on the rail system, wherein the clamp has a length L that enables the operator to connect the clamp to the rail system when seated in the service vehicle.

The automated storage and retrieval system may comprise: a plurality of storage containers, a plurality of vertical storage columns for stacking storage containers, and a remotely operated vehicle configured to move along the rail system and to transport at least one storage containers.

The automated storage and retrieval system may comprise a control system configured to monitor and control wirelessly movements of the remotely operated vehicle(s).

The remotely operated vehicle may comprise a lifting device configured to grab and vertically lift a storage container.

The automated storage and retrieval system may comprise a safety harness.

The automated storage and retrieval system may comprise one or more service plate(s) for covering up an opening in the rail system. The service plates can be used to form a platform for an operator at a service area.

The present disclosure relates to a method for anchoring a safety harness to a rail system using a clamp, wherein the rail system comprises: a first set of parallel rails arranged in a horizontal plane and extending in a first direction X, and a second set of parallel rails arranged in the horizontal plane and extending in a second direction Y which is orthogonal to the first direction X, wherein the first and second sets of rails form a grid pattern in the horizontal plane, the grid pattern comprising a plurality of openings, each opening being defined by a pair of neighbouring rails of the first set of rails, a pair of neighbouring rails of the second set of rails, and four junctions where each rail of the first set of rails meets one of the rails of the second set of rails, wherein the method comprises the step of clamping the clamp to a junction of the rails, the clamp straddling the junction by clamping across diagonally opposed corners of the junction.

The present disclosure relates to a method for anchoring a safety harness to a rail system using a clamp, wherein the rail system comprises: a first set of parallel rails arranged in a horizontal plane and extending in a first direction X, and a second set of parallel rails arranged in the horizontal plane and extending in a second direction Y which is orthogonal to the first direction X, wherein the first and second sets of rails form a grid pattern in the horizontal plane, the grid pattern comprising a plurality of openings, each opening being defined by a pair of neighbouring rails of the first set of rails, a pair of neighbouring rails of the second set of rails, and four junctions where each rail of the first set of rails meets one of the rails of the second set of rails, wherein the method comprises the step of clamping the clamp to one rail extending in the first direction X or in the second direction Y, the clamp straddling the rail by clamping across opposed sides of the rail.

The clamp used in the method may be a clamp as described herein.

The present disclosure relates to a method for anchoring a safety harness to a rail system using a clamp as disclosed herein, wherein the rail system is part of an automated storage and retrieval system as disclosed herein, wherein the method comprises the steps of opening the clamp by moving the first jaw and the second jaw away from each other to increase a jaw gap between them, placing the clamp onto the rail system with the first jaw and the second jaw on opposite sides of one rail or a junction, engaging the first jaw with one rail extending in the first direction X and/or one rail extending in the second direction Y, closing the clamp by moving the first jaw and the second jaw towards each other to reduce the jaw gap until the second jaw is engaged with one rail extending in the first direction X and/or one rail extending in the second direction Y.

Accordingly, the clamp can be connected to a rail extending in the first direction X, or connected to a rail extending in the second direction Y, or connected to a junction of rails.

If each rail comprises two vertical sides and is formed with a horizontal groove provided in each vertical side of the rail, and the grooves on the first set of parallel rails are positioned to align with the grooves on the second set of parallel rails at the junctions, and if the clamp comprises a first tooth arranged on the first jaw, and a second tooth arranged on the second jaw, the method may comprises the steps of: engaging the first tooth with one groove of a rail extending in the first direction X and/or one groove of a rail extending in the second direction Y, and engaging the second tooth with another groove of the rail extending in the first direction X and/or another groove of the rail extending in the second direction Y by closing the clamp.

Accordingly, the clamp can be connected to a rail extending in the first direction X, or connected to a rail extending in the second direction Y, or connected to a junction of rails.

The part of the jaws not provided with a tooth may preferably engage the part of the vertical sides not provided with a groove, while the teeth are engaged with the grooves.

The sides of the junction at which the first jaw and the second jaw are placed are diagonally arranged, i.e. not arranged on the same side of the rail extending in the first direction or on the same side of the rail extending in the second direction.

The method may comprise the step of locking the clamp to the rail system by preventing relative movement of the first jaw and the second jaw.

Relative movement of the first jaw and the second jaw may be prevented by means of the clamp being self-locking, e.g. as a locking plier type.

Relative movement of the first jaw and the second jaw may be prevented by means of the clamp comprises a locking mechanism as described herein.

The method may comprise the step of connecting a harness to a connection point on the clamp.

The harness may preferably be connected to the connection point before the clamp is clamped to the junction.

The method may comprise the step of transporting an operator to a service area on the rail system by means of a service vehicle, before the clamp is clamped to the junction adjacent the service area.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a clamp configured to anchor a safety harness to a rail system, the clamp comprising a first jaw, a second jaw, and an attachment point for a safety harness.

FIG. 6 is a front view of the clamp in FIG. 5.

FIG. 7 is a front view of a safety harness and a tether that can be used in combination with the clamp in FIG. 5.

FIG. 8 is a perspective view of the clamp in FIG. 5 in a released configuration and positioned straddling a junction of a rail system.

FIG. 9 is a perspective view of the clamp in FIG. 5 in a clamped configuration engaging opposite corners of the junction such that the clamp is connected to the rail system.

FIG. 10 is another perspective view of the clamp in FIG. 9.

FIG. 11 is perspective view of an automated storage and retrieval system comprising a rail system, in which automated storage and retrieval system an operator is wearing a safety harness anchored to the rail system.

FIG. 12 is detail view from FIG. 11 illustrating how the safety harness can be anchored to the rail system by means of the clamp and a tether.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

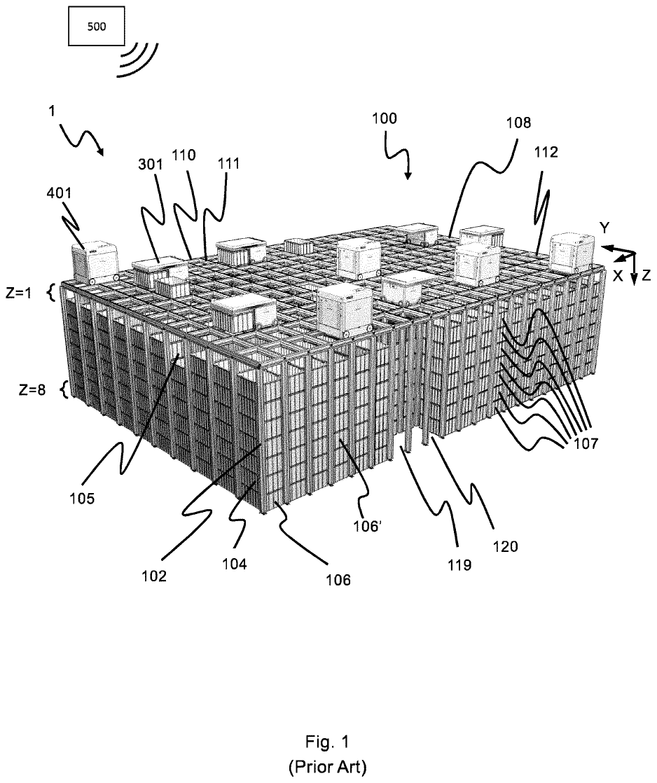

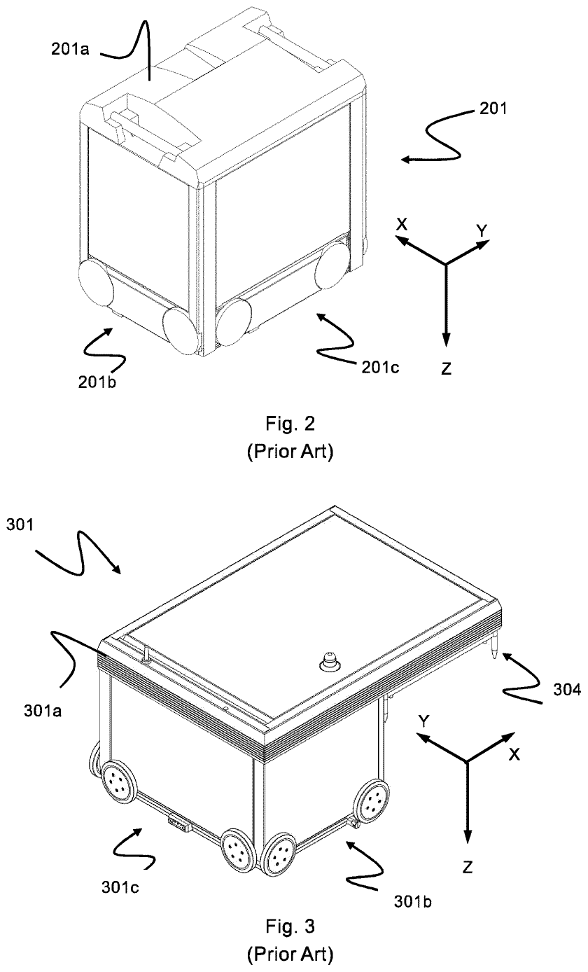

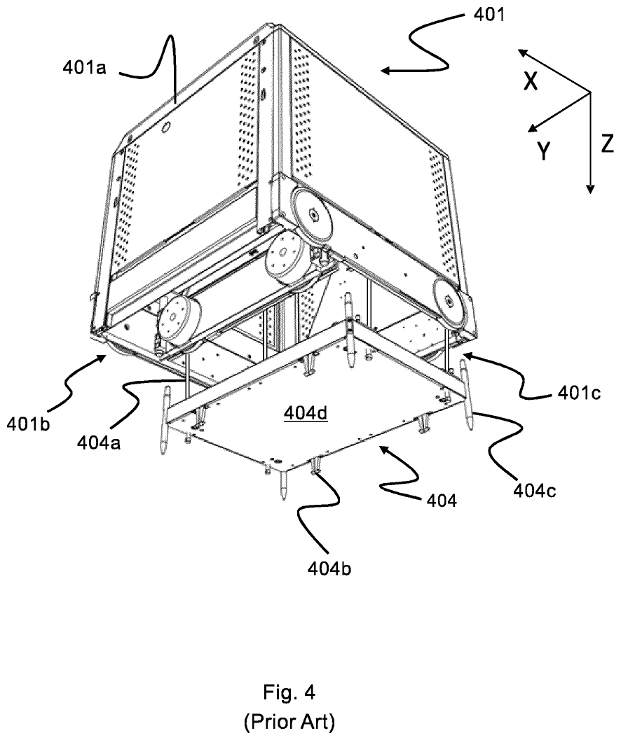

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

One embodiment of the automated storage and retrieval system according to the invention will now be discussed in more detail with reference to Figs.

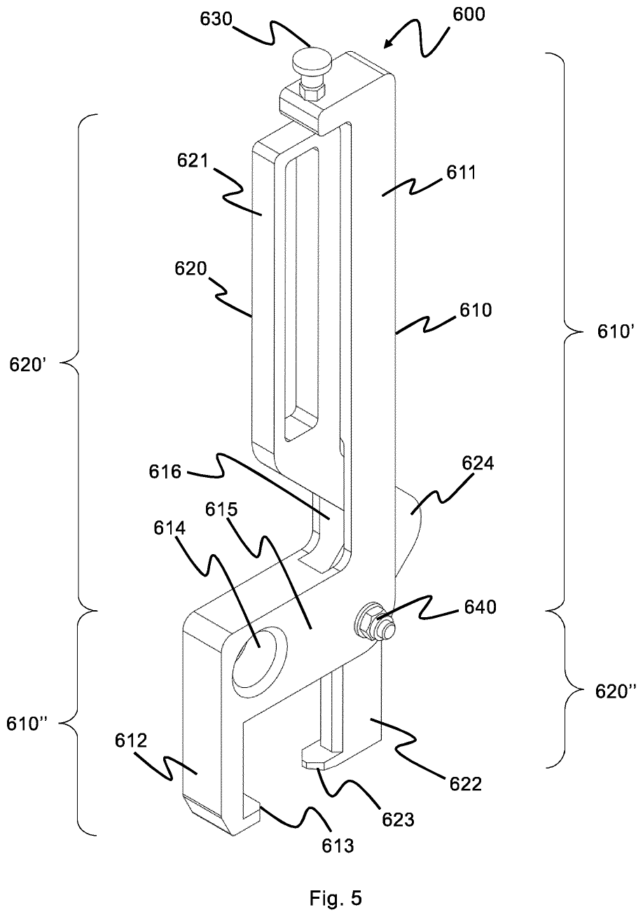

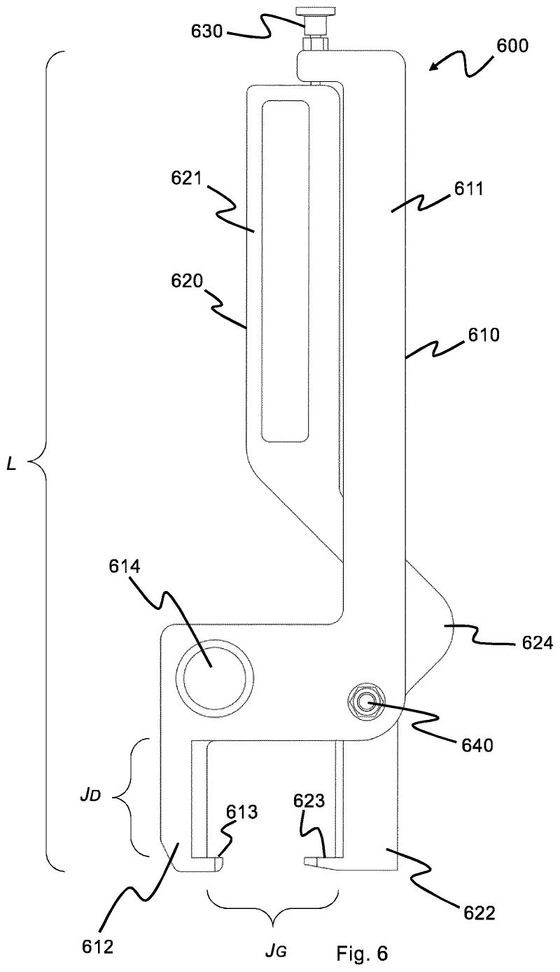

FIG. 5 shows a clamp 600 for anchoring a safety harness 700 to a rail system 108. The rail system 108 may be part of an automated storage and retrieval system 1. Such a rail system 108 is typically arranged at a height above the floor making movement thereon hazardous for a human operator 960 unless safety measures are taken. In particular, falling down from the rail system is likely to cause injuries. By wearing a safety harness 700 that is anchored to the rail system 108, the operator's safety can be improved.

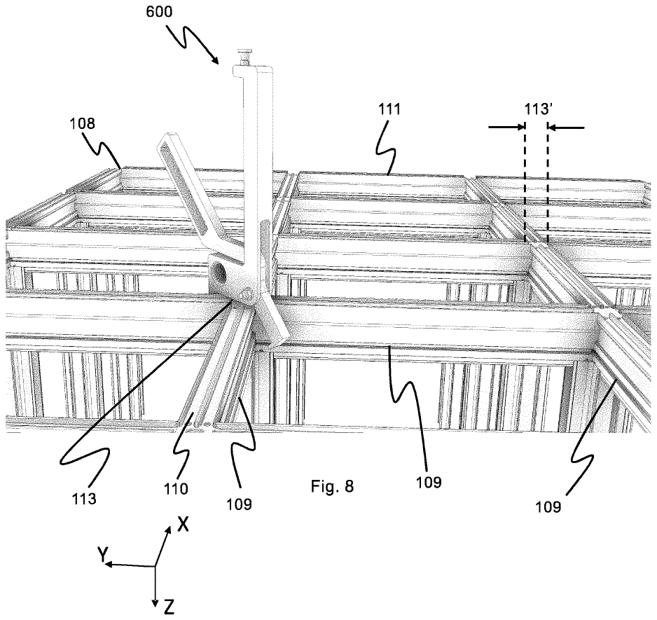

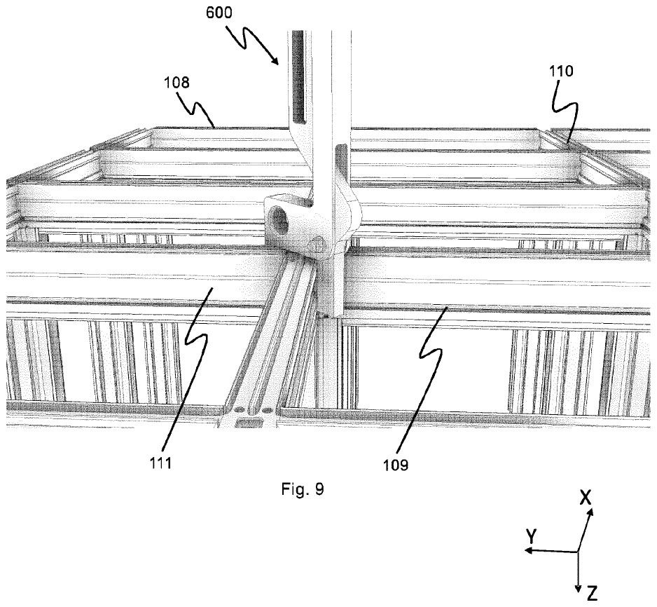

An example of such a rail system 108 is shown in FIG. 8. The rail system 108 may comprise a first set of parallel rails 110 arranged in a horizontal plane P_{H} and extending in a first direction X, and a second set of parallel rails 111 arranged in the horizontal plane P_{H} and extending in a second direction Y which is orthogonal to the first direction X.

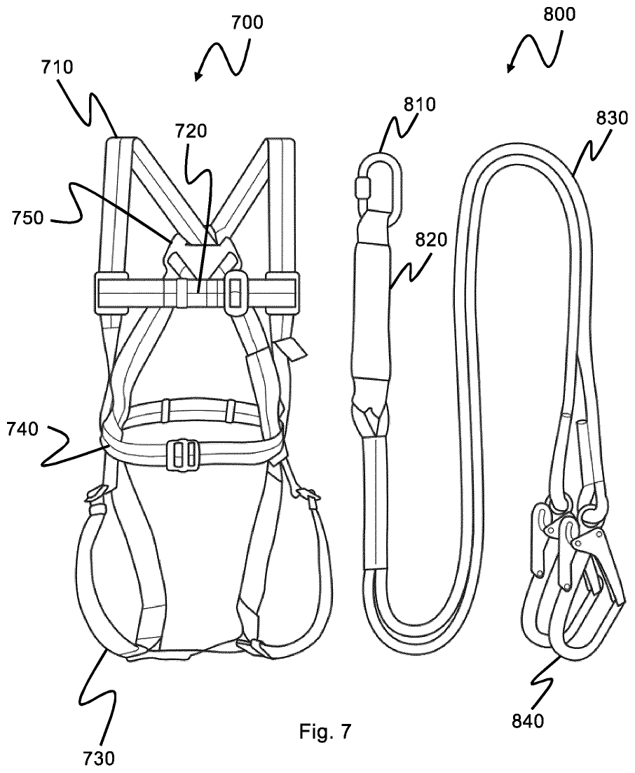

The clamp 600 shown in FIG. 5 and FIG. 6 comprises a first jaw 612, a second jaw 622, and an attachment point 614 for a safety harness 700. Furthermore, the clamp 600 may comprise a first tooth 613 arranged on the first jaw 612, and a second tooth 623 arranged on the second jaw 622.

The clamp 600 may comprise a first arm 610, and a second arm 620 connected to the first arm 610 at a pivot 640. Furthermore, the first arm 610 and the second arm 620 may each have a first part 610′,620′ and a second part 610″,620″. The first parts 610′,620′ and the second parts 610″,620″ are on opposite sides of the pivot 640.

The first parts 610′,620′ may form levers 611,621 and the second parts 610″,620″ may form the jaws 612,622, such that the levers 611,621 can be used to operate the jaws 612,622 relative each other.

The jaws 612,622 may be operated in a pivoting manner. As the jaws 612,622 pivot relative each other, a jaw gap J_{G} between distal ends of the jaws 612,622 is adjusted. The jaw gap J_{G} may be increased by pivoting the levers 611,621 away from each other and reduced by pivoting the levers 611,621 towards each other.

The clamp 600 is operable between a released configuration as shown in FIG. 8 and a clamped configuration as shown in FIGS. 5, 6, and 9-12. The first jaw 612 and the second jaw 622 are configured to engage opposite corners of the junction 113 when the clamp 600 is in the clamped configuration.

The clamp 600 may comprises a releasable locking mechanism 630 configured to lock the jaws 612,622 in the clamped configuration.

The releasable locking mechanism 630 may be arranged on the first lever 611 and configured to releasably lock the first lever 611 to the second lever 621, such that relative movement between the first lever 611 and the second lever 621 is prevented, and thus relative movement between the jaws 612,622 is prevented.

The clamp 600 may be arranged to be operated as a scissor mechanism to clamp the jaws 612,622 around the junction 113 of the rails.

The first lever 611 and the second lever 621 may be parallel when the clamp 600 is in the clamped configuration, and the first jaw 612 and the second jaw 622 may be parallel when the clamp 600 is in the clamped configuration.

FIGS. 8-12 shows that each rail 110,111 may comprise two vertical sides and that each rail 110,111 may be formed with a horizontal groove 109 provided in each vertical side of the rail 110,111. Furthermore, the grooves 109 on the first set of parallel rails 110 may be positioned to align with the grooves 109 on the second set of parallel rails 111 at the junctions 113. Two grooves 109 may thus meet at each of the four corners of each junction 113. All the grooves 109 may be arranged in the same horizontal plane.

FIGS. 8-12 shows how the first tooth 613 and the second tooth 623 are configured to engage the grooves 109 across opposite corners of the junction when the clamp 600 is in the clamped configuration.

The teeth 613,623 may be configured to be engaged with the grooves 109 of the rail system 108 when the clamp 600 is operated such that the first jaw 612 and the second jaw 622 are parallel.

The second part 610″ of the first arm 610 may form a surface for the clamp 600 to be supported on top of the rail system 108 as illustrated inter alia in FIG. 8. This may aid the connection of the clamp 600 to the rail system 108. Particularly if the surface is arranged at a distance from the first tooth 613 defining a jaw depth J_{D} corresponding to a distance between the top of the rail 110,111 and the groove 109.

As illustrated in FIGS. 5 and 6, an inner side of the first jaw 612 is facing an inner side of the second jaw 622. Furthermore, the inner side of the first jaw 612 may be chamfered towards the second jaw 622 and the inner side of the second jaw 622 may be chamfered towards the first jaw 612.

The chamfering of the first jaw 612 may form a 90° angle, and the chamfering of the second jaw 622 may form a 90° angle. The chamfering may thus correspond to the angle between two rails 110,111 at a corner of the junction 113.

The chamfering of the first jaw 612 and the chamfering of the second jaw 622 may form pairwise parallel surfaces, i.e. one chamfer of the first jaw 612 may be parallel to a first chamfer of the second jaw 622, and a second chamfer of the first jaw 612 may be parallel to a second chamfer of the second jaw 622.

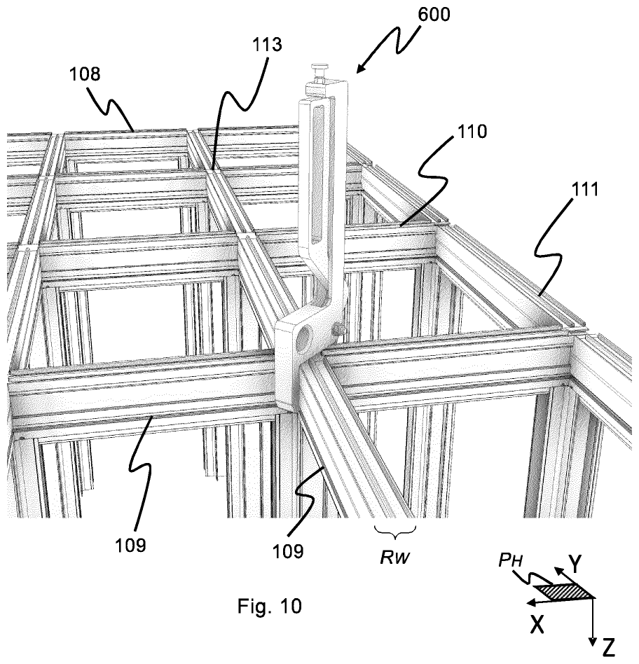

As illustrated in FIGS. 9 and 10, the inner side of the first jaw 612 may be configured to engage one vertical side of one of the rails 110 extending in the first direction X and simultaneously engage one vertical side of one of the rails 111 extending in the second direction Y, and the inner side of the second jaw 622 is configured to engage another vertical side of the rail 110 extending in the first direction X and simultaneously engage another vertical side of the rail 111 extending in the second direction Y such that the clamp 600 straddle the junction 113 when the clamp 600 is in the clamped configuration and the first tooth 613 and the second tooth 623 engage respective grooves 109 on opposite corners of the junction 113.

FIGS. 5 and 6 show how the first tooth 613 may extend towards the second jaw 622 and the second tooth 623 may extend towards the first jaw 612. Furthermore, the first tooth 613 may be chamfered towards the second jaw 622 and the second tooth 623 may be chamfered towards the first jaw 612.

The chamfering of the first tooth 613 may form a 90° angle and the chamfering of the second tooth 623 may form a 90° angle. The chamfering may thus correspond to the angle between two groves 109 at a corner of the junction 113.

The chamfering of the first tooth 613 and the chamfering of the second tooth 623 form pairwise parallel surfaces i.e. one chamfer of the first tooth 613 may be parallel to a first chamfer of the second tooth 623, and a second chamfer of the first tooth 613 may be parallel to a second chamfer of the second tooth 623.

Additionally, or alternatively, the chamfering of the first tooth 613 and the chamfering of the first jaw 612 may form pairwise parallel surfaces, and the chamfering of the second tooth 623 and the chamfering of the second jaw 622 may form pairwise parallel surfaces.

The first part 610′ of the first arm 610 may be provided with an opening 616 through which the second arm 620 is sandwiched.

FIGS. 5 and 6 show that the clamp 600 may comprise an attachment part 615 arranged in the second part 610″ of the first arm 610. The attachment point 614 of the clamp 600 may be a through-hole arranged in the attachment part 615. The attachment point 614 allows a safety harness 700 to be connected to the clamp 600, e.g. by means of a tether 800.

FIG. 7 shows a safety harness 700 and a tether 800 that can be used with the clamp 600. The safety harness 700 is configured to be worn by an operator 960.

The safety harness 700 may comprise: shoulder straps 710, a chest strap 720, leg straps 730, a waist strap 740, and a dorsal ring 750. The tether 800 may be connected to the dorsal ring 750.

The tether may comprise: a carabiner 810 connectable to the safety harness 700, a shock absorber 820, a lanyard 830, and snap hooks 840 connectable to the clamp 600.

The clamp 600, the safety harness 700, and the tether 800 may together constitute a safety system for use on a rail system 108 as disclosed herein.

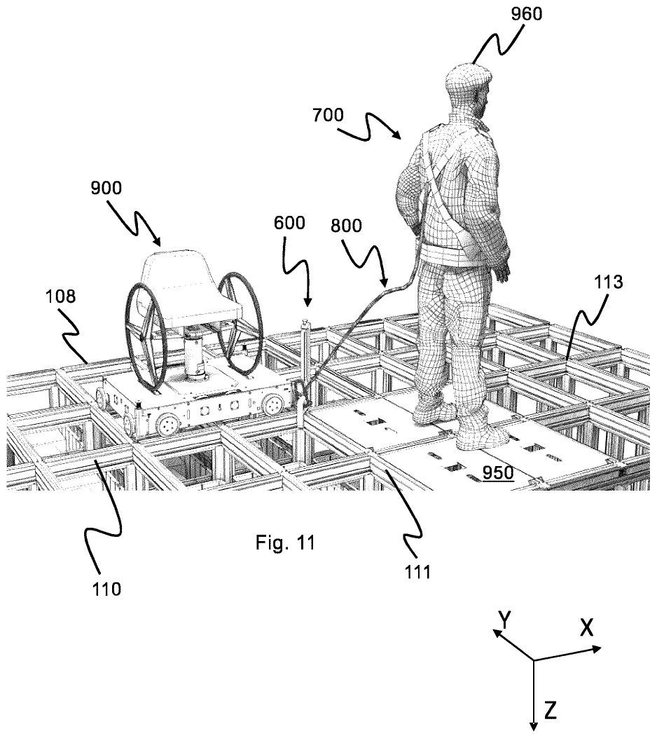

The safety system may further comprise a safety plate 950 and/or a service vehicle 900, as illustrated in FIG. 11.

The service vehicle 900 is configured for transportation of an operator 960 on the rail system 108. The service vehicle 900 may comprise a wheeled base on which the operator 960 can sit or stand safely when the service vehicle 900 is moving.

The service vehicle 900 may comprise a first set of wheels arranged to engage with two adjacent rails of the first set 110 of rails and a second set of wheels arranged to engage with two adjacent rails of the second set 111 of rails. At least one of the sets of wheels can be lifted and lowered, so that the first set of wheels and/or the second set of wheels can be engaged with the respective set of rails 110, 111 at any one time. The service vehicle 900 may be motorised or powered by the operator 960, e.g. in a similar manner as a wheelchair.

The service plate 950 is preferably configured to cover one or more openings in the rail system 108. The service plate 950 is preferably configured for handling by the operator 960.

FIGS. 8-12 show an automated storage and retrieval system 1 comprising a rail system 108. The rail system 108 comprises a first set of parallel rails 110 arranged in a horizontal plane P_{H} and extending in a first direction X, and a second set of parallel rails 111 arranged in the horizontal plane P_{H} and extending in a second direction Y which is orthogonal to the first direction X, wherein the first and second sets of rails 110,111 form a grid pattern in the horizontal plane P_{H}, the grid pattern comprising a plurality of openings 112, each opening 112 being defined by a pair of neighbouring rails of the first set of rails 110, a pair of neighbouring rails of the second set of rails 111, and four junctions 113 where each rail of the first set of rails 110 meets one of the rails of the second set of rails 111. The automated storage and retrieval system 1 also comprise a clamp 600. The clamp 600 may of the type disclosed herein.

The junction 113 has a junction width 113′ between two opposing corners. The clamp 600 may have a jaw gap J_{G} adapted to the junction width 113′. The jaw gap J_{G} is then configured such that the clamp 600 can straddle the junction 113 and provide a tight fit on the junction 113 when in the clamped configuration.

Each rail 110,111 may comprise two horizontal grooves 109 arranged on respective vertical sides of the rail 110,111. The grooves 109 on the first set of parallel rails 110 are arranged to intersect the grooves 109 on the second set of parallel rails 111 at junctions 113 between the first set of parallel rails 110 and the second set of parallel rails 111.

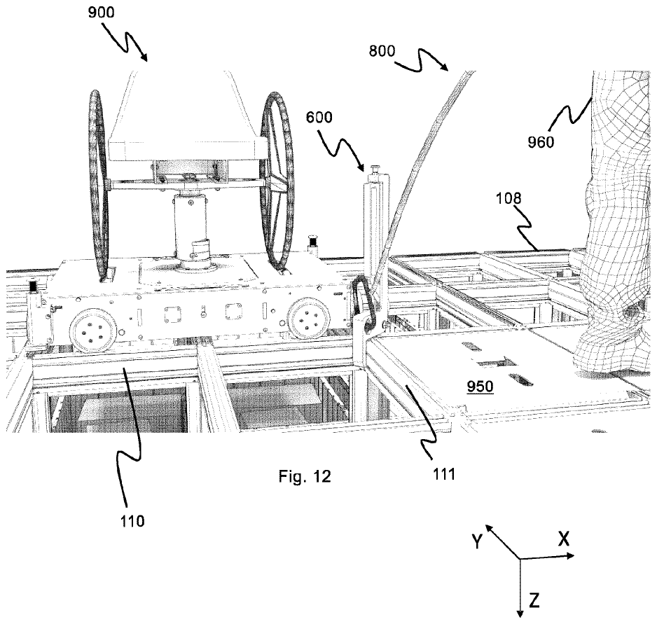

FIGS. 11 and 12 illustrates that the automated storage and retrieval system 1 may comprise a service vehicle 900 for transporting the operator 960 on the rail system 108. The clamp 600 preferably has a length L that enables the operator 960 to connect the clamp 600 to the rail system 108 when seated or while staying safely in the service vehicle 900, i.e. without having to bend or lean outside the service vehicle 900 such that the risk of falling is reduced.

The automated storage and retrieval system 1 may comprises: a plurality of storage containers 106, a plurality of vertical storage columns 105 for stacking storage containers 106, and a remotely operated vehicle 201; 301; 401 configured to move along the rail system 108 and to transport at least one storage container 106.

In FIG. 8, the clamp 600 has been opened by moving the first jaw 612 and the second jaw 622 away from each other to increase a jaw gap J_{G} between their distal ends. This is typically done by moving the first lever 611 and the second lever 621 away from each other. The clamp 600 is then in a released configuration and can be placed onto the rail system 108 with the first jaw 612 and the second jaw 622 on opposite sides of a junction 113. The first tooth 613 can then be engaged with one groove 109 of a rail 110 extending in the first direction X and one groove 109 of a rail 111 extending in the second direction Y.

In FIGS. 9 and 10, the clamp 600 has been closed by moving the first jaw 612 and the second jaw 622 towards each other to reduce a jaw gap J_{G} between their distal ends until the second tooth 623 is engaged with another groove 109 of the rail 110 extending in the first direction X and another groove 109 of the rail 111 extending in the second direction Y. This is typically done by moving the first lever 611 and the second lever 621 towards each other. The clamp 600 is then in a clamped configuration.

When the clamp 600 is in the clamped configuration and engaged with the rail system 108, the clamp 600 can be locked to the rail system 108 by preventing relative movement of the first jaw 612 and the second jaw 622. Relative movement of the first jaw 612 and the second jaw 622 can be achieved by means of a locking mechanism 630.

One example of a locking mechanism 630 is a lock pin arranged on the first lever 611 and biased towards the second lever 621. The second lever 621 having a hole or similar for receiving the lock pin. One the lock pin has entered the hole, the clamp 600 is locked in the clamped configuration until the operator 960 actively releases the locking mechanism 630.

The lock pin may be arranged in a part of the first lever 611 that is cantilevered over a part of the second lever 621 when the clamp 600 is in the clamped configuration. The hole for receiving the lock pin in the second lever 621 is then arranged in a part of the second lever 621 such that it aligns with the lock pin when the clamp 600 is in the clamped configuration.

The locking mechanism 630 may have a handle or other type of gripping element for the operator 960 to grab and pull to release the locking mechanism 630 such that the clamp can be operated to the released configuration and lifted off the rail system 108.

As illustrated in FIG. 5, the locking mechanism 630 may comprise a knob for the operator 960 to retract the lock pin to release the first lever 611 from the second lever 621.

FIGS. 11 and 12 show how the clamp 600 can be used for anchoring the safety harness 700 to a rail system 108 when the clamp 600 is connected to the rail system 108. As illustrated, the safety harness 700 worn by the operator 960 may be connected to the clamp 600 via a tether 800. The safety harness 700 can be connected to the clamp 600 at any time. However, connecting the safety harness 600 to the clamp 600 before the clamp 600 is connected to the rail system 108 is preferred for safety reasons.

The clamp 600 comprises an attachment point 614 for connecting the safety harness 600. The attachment point 614 may preferably be arranged below the pivot point 640, e.g. on an attachment part 615 of the second part 610″ of the first arm 610. In that way the attachment point 614 can be located close to the rail system 108 when the clamp 600 is connected to the rail system 108.

As indicated in FIGS. 11 and 12, the operator 960 may be transported to a service area on the rail system 108 by means of the service vehicle 900. When reaching the service area, the operator 960 can connect the clamp 600 to a junction 113 in the service area or in the vicinity of the service area.

Alternatively, one or more clamps 600 may be connected to the rail system 108 prior to the operator 960 reaching the service area. However, then the operator 960 must connect the safety harness 700 to the clamp 600 while the clamp 600 is connected to the rail system 108.

At the service area, a work area may be created for the operator 960 by arranging service plates 950 on top of the rail system 108, as exemplified in FIGS. 11 and 12.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
100 Framework structure
102 Upright members of framework structure
104 Storage grid
105 Storage column
106 Storage container
106′ Particular position of storage container
107 Stack
108 Rail system
109 Groove
110 Parallel rails in first direction (X)
111 Parallel rails in second direction (Y)
112 Opening
113 Junction
113′ Junction width
115 Cell
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
600 Clamp
610 First arm
610′ First part of the first arm
610″ Second part of the first arm
611 First lever
612 First jaw
613 First tooth
614 Attachment point for harness
615 Attachment part
616 Opening in the first part of the first arm
620 Second arm
620′ First part of the second arm
620″ Second part of the second arm
621 Second lever
622 Second jaw
623 Second tooth
624 Kink
624 Hole for lock pin
630 Locking mechanism
640 Pivot/pivot point
700 Safety harness
710 Shoulder strap
720 Chest strap
730 Leg strap
740 Waist strap
750 Dorsal ring
800 Tether
810 Carabiner
820 Shock absorber
830 Lanyard
840 Snap hook
900 Service vehicle
950 Service plate
960 Operator
X First direction
Y Second direction
Z Third direction
P_{H} Horizontal plane
J_{D} Jaw depth
J_{G} Jaw gap
L Length of the clamp
R_{W} Rail width

1. A clamp for anchoring a safety harness to a rail system,
wherein the rail system comprises:
a first set of parallel rails arranged in a horizontal plane and extending in a first direction, and
a second set of parallel rails arranged in the horizontal plane and extending in a second direction which is orthogonal to the first direction,
wherein the first and second sets of rails form a grid pattern in the horizontal plane, the grid pattern comprising a plurality of openings, each opening being defined by a pair of neighbouring rails of the first set of rails, a pair of neighbouring rails of the second set of rails, and four junctions where each rail of the first set of rails meets one of the rails of the second set of rails,
wherein the clamp comprises:
an attachment point for a safety harness,
a first jaw, and
a second jaw,
wherein the clamp is operable between clamped and released configurations to pivot the first jaw and the second jaw relative to each other and thereby adjust a jaw gap between distal ends of the first jaw and second jaw,
wherein the first jaw and the second jaw are configured to engage opposite sides of a rail of the first set of rails (110) or the second set of rails when the clamp is in the clamped configuration, and/or
wherein the first jaw and the second jaw are configured to engage opposite corners of the junction when the clamp is in the clamped configuration.

2. The clamp according to claim 1,
wherein the clamp comprises:
a first tooth arranged on the first jaw, and
a second tooth arranged on the second jaw.

3. The clamp according to claim 2,
wherein each rail comprises two vertical sides and is formed with a horizontal groove provided in each vertical side of the rail,
wherein the grooves on the first set of parallel rails are positioned to align with the grooves on the second set of parallel rails at the junctions,
wherein the first tooth and the second tooth are configured to engage grooves on opposite sides of a rail of the first set of rails or the second set of rails when the clamp is in the clamped configuration, and/or
wherein the first tooth and the second tooth are configured to engage the grooves across opposite corners of the junction between a rail extending in the first direction and a rail extending in the second direction when the clamp is in the clamped configuration.

4. The clamp according to claim 1,
wherein the clamp is arranged to be operated as a scissor mechanism to clamp the first jaw and second jaw around one rail or the junction of the rails.

5. The clamp according to claim 1,
wherein the clamp comprises:
a first arm, and
a second arm connected to the first arm at a pivot,
wherein the first arm and the second arm each have a first part and a second part, the first parts and the second parts are on opposite sides of the pivot,
wherein the first parts form levers and the second parts form the first jaw and second jaw, such that the levers can be used to operate the first jaw and second jaw relative each other.

6. The clamp according to claim 5,
wherein the first lever, the second lever, the first jaw, and the second jaw are parallel when the clamp is in the clamped configuration.

7. The clamp according to claim 1,
wherein the clamp comprises:
a releasable locking mechanism configured to lock the first jaw and second jaw in the clamped configuration.

8. The clamp according to claim 5,
wherein the clamp comprises an attachment part arranged in the second part of the first arm,
wherein the attachment point is a through-hole arranged in the attachment part.

9. The clamp according to any one of claim 3,
wherein the teeth are configured to be engaged with the grooves of the rail system when the clamp is operated such that the first jaw and the second jaw are parallel.

10. The clamp according to any one of claim 5,
wherein the second part of the first arm forms a surface for the clamp to be supported on top of the rail system.

11. A safety system for use on the rail system of claim 1,
wherein the safety system comprises:
the clamp according to claim 1,
a safety harness, and
a tether configured to couple the harness to the clamp.

12. An automated storage and retrieval system, wherein the automated storage and retrieval system comprises:
clamp according to claim 1, and
the rail system according to claim 1,
wherein the automated storage and retrieval system is configured to automatically store and retrieve a plurality of storage containers.

13. The automated storage and retrieval system according to claim 12,
wherein each rail of the rail system further comprises two horizontal grooves arranged on respective vertical sides of the rail,
wherein the grooves on the first set of parallel rails are arranged to intersect the grooves on the second set of parallel rails at junctions between the first set of parallel rails and the second set of parallel rails.

14. The automated storage and retrieval system according to claim 12,
wherein the automated storage and retrieval system further comprises:
a service vehicle for transporting an operator on the rail system,
wherein the clamp has a length that enables the operator to connect the clamp to the rail system when seated in the service vehicle.

15. The automated storage and retrieval system according to claim 12,
wherein the automated storage and retrieval system comprises:
the plurality of storage containers,
a plurality of vertical storage columns for stacking storage containers, and
a remotely operated vehicle configured to move along the rail system and to transport at least one storage container of the plurality of storage containers.

16. A method for anchoring a safety harness to a rail system of claim 1 using a clamp according to claim 1,
wherein the rail system is part of an automated storage and retrieval system
wherein the method comprises the steps of:
opening the clamp by moving the first jaw and the second jaw away from each other to increase a jaw gap between them,
placing the clamp onto the rail system with the first jaw and the second jaw on opposite sides of one rail or a junction,
engaging the first jaw with one rail extending in the first direction and/or one rail extending in the second direction,
closing the clamp by moving the first jaw and the second jaw towards each other to reduce the jaw gap until the second jaw is engaged with one rail extending in the first direction and/or one rail extending in the second direction.

17. The method according to claim 16,
wherein each rail comprises two vertical sides and is formed with a horizontal groove provided in each vertical side of the rail
wherein the grooves on the first set of parallel rails are positioned to align with the grooves on the second set of parallel rails at the junctions,
wherein the clamp comprises:
a first tooth arranged on the first jaw, and
a second tooth arranged on the second jaw,
wherein the method comprises the steps of:
engaging the first tooth with one groove of a rail extending in the first direction and/or one groove of a rail extending in the second direction, and
engaging the second tooth with another groove of the rail extending in the first direction and/or another groove of the rail extending in the second direction, by closing the clamp.

18. The method according to claim 16, wherein the method comprises the step of:
locking the clamp to the rail system by preventing relative movement of the first jaw and the second jaw.

19. The method according to claim 16, wherein the method comprises the step of:
connecting a harness to a connection point on the clamp.

20. The method according to claim 16, wherein the method comprises the step of:
transporting an operator to a service area on the rail system using a service vehicle, before the clamp is clamped to a junction adjacent the service area.
